(19) United States
(12) Patent Application Publication
(10) Pub. No.: US 2025/0389425 A1
(43) Pub. Date: Dec. 25, 2025

(54) ELECTRIC GRILL EQUIPPED WITH DOUBLE AIR CURTAIN-TYPE DUAL AIR PURIFICATION AND CIRCULATION SYSTEM

(71) Applicant: DAWON E&A CO., LTD., Gimpo-si (KR)

(72) Inventor: Seong-Hyuk CHOI, Seoul (KR)

(21) Appl. No.: 19/317,496

(22) Filed: Sep. 3, 2025

Related U.S. Application Data
(63) Continuation of application No. PCT/KR2024/012903, filed on Aug. 28, 2024.

(30) Foreign Application Priority Data
Aug. 29, 2023 (KR) 10-2023-0113520

(51) Int. Cl. F24C 15/20

(52) U.S. Cl. CPC F24C 15/2042; F24C 15/2057

(57) ABSTRACT

The present invention relates to an electric grill equipped with a double air curtain-type that includes first and second suction fans and a radiation plate having first and second discharge holes, the grill having partitions, a plurality of third and fourth discharge holes, and a first flow switching part, wherein the third and fourth discharge holes of the partitions are spaced upwards apart from the first and second discharge holes, the partitions are positioned between side walls of the grill body and side plates of the radiation plate such that the air discharged from the first and second suction fans is bifurcated into an air flow discharged through the first and second discharge holes and an air flow discharged through the third and fourth discharge holes, and the latter air flow is positioned above the former air flow so as to form a double air curtain.

### CROSS-REFERENCE TO RELATED APPLICATIONS

This application is a Continuation of Application No. PCT/KR2024/012903, filed on Aug. 28, 2024, which in turn claims the benefit of Korean Patent Application No. 10-2023-0113520, filed on Aug. 29, 2023. The entire disclosures of all these applications are hereby incorporated by reference.

### TECHNICAL FIELD

The present invention relates to an electric grill, and more particularly to an electric grill equipped with a dual air purification and circulation system capable of eliminating oil vapor and smoke generated during cooking of foodstuffs.

### Background Art

In general, households and restaurants are equipped with an electric grill including a grill plate having a plurality of oil discharge holes formed therein, and an oil tray disposed below the grill plate to collect oil dripping through the oil discharge holes.

In such electric grills, although a portion of the oil generated during meat grilling is discharged to the oil tray through the oil discharge holes of the grill plate, a relatively large amount of oil splashes outwards, thereby contaminating the surroundings of the electric grill. In addition, odors and smoke generated during meat grilling spread into the interior space, causing contamination of the air in the interior space. Furthermore, because the heat from the grill is released into the interior space during the meat grilling, the cooking time is prolonged, resulting in increased power consumption.

In order to solve the above-mentioned problems, referring to FIG. 1, the present inventor has developed, applied for, and been granted a patent for an electric grill equipped with a dual air purification and circulation system, wherein a suction fan includes a first suction fan 121 and a second suction fan 122 disposed on both sides of a lower space of the grill body 100, with an oil tray 110 interposed therebetween and located below the oil discharge nozzle 171 of the grill plate 170, wherein the first suction fan 121 forms a first air circulation flow by suctioning, through the oil discharge nozzle 171, air containing oil vapor, smoke, heat and odor generated in the space on the grill plate 170, and then supplying the air back to the space on the grill plate 170 through a first discharge hole 153 in a radiation plate 150, and the second suction fan 122 forms a second air circulation flow by suctioning, through the oil discharge nozzle 171, air containing oil vapor, smoke, heat and odor generated in the space on the grill plate 170, and then supplying the air back to the space on the grill plate 170 through a second discharge hole 154 of the radiation plate 150, and wherein the oil vapor, smoke, heat and odor discharged through the oil discharge nozzle 171 by the suction force of the first and second suction fans 121 and 122 come into contact with the water stored in the oil tray 110 located below the oil discharge nozzle 171 so as to be purified and is introduced into the first and second suction fans 121, 122. (See “Patent Document 1” below.)

However, in the conventional electric grill disclosed in “Patent Document 1,” as shown by the black arrows indicating the airflow in FIG. 1, the air supplied to the space on the grill plate 170 through the first discharge hole 153 and the second discharge hole 154 in the radiation plate 150 collide with each other above the oil discharge nozzle 171 of the grill plate 170. As a result, not all of the air is suctioned into the oil discharge nozzle 171, and a portion of the air diffuses to the outside of the grill body 100. Consequently, odors and smoke generated during meat grilling still spread into the indoor space, thereby causing a problem of indoor air pollution.
[Patent Document 1] Korean Patent Registration No. 10-2273313B1 (2021.07.05.)

### DISCLOSURE

### Technical Problem

Therefore, the present invention has been made in view of the above problems, and it is an object of the present invention to provide an electric grill equipped with a double air curtain-type dual air purification and circulation system, capable of completely preventing the diffusion of air containing oil vapor, smoke, heat and odor, generated during meat grilling, to the outside of the grill body.

### Technical Solution

In accordance with the present invention, the above and other objects can be accomplished by the provision of an electric grill equipped with a double air curtain-type dual air purification and circulation system, including a grill body, an oil tray disposed in a lower portion of the grill body to store water therein, suction fans disposed at both lateral sides of the oil tray, a radiation plate coupled to the grill body at a position spaced upwards apart from the oil tray and the suction fans, a through hole being longitudinally formed in a center of a bottom plate of the radiation plate and a plurality of first discharge holes and a plurality of second discharge holes being respectively formed in both lateral plates of the radiation plate spaced apart from both lateral walls of the grill body, and a grill plate spaced upwards apart from the bottom plate of the radiation plate so as to be positioned above the first discharge holes and the second discharge holes in the radiation plate, an oil discharge nozzle being longitudinally formed in a center of the grill plate, wherein the suction fans comprises first and second suction fans positioned at both sides of a lower space of the grill body with the oil tray disposed below the oil discharge nozzle being interposed therebetween, the first suction fan sucks air containing oil vapor, smoke, heat and odor, generated in a space on the grill plate, through the oil discharge nozzle and supplies the air to the space on the grill plate through the first discharge holes in the radiation plate, thus creating a first air circulation flow, and the second suction fan sucks air containing oil vapor, smoke, heat and odor, generated in the space on the grill plate, through the oil discharge nozzle and supplies the air to the space on the grill plate through the second discharge holes in the radiation plate, thus creating a second air circulation flow, wherein, by virtue of suction force of the first and second suction fans, the air containing the oil vapor, the smoke, the heat and the odor, discharged from the oil discharge nozzle, is brought into contact with water stored in the oil tray positioned below the oil discharge nozzle so as to be purified and is introduced into the first and second suction fans, the two lateral walls of the grill body are respectively provided with partition walls, each of which is bent into a “U” shape at an upper end of an upper end of each of the two lateral walls and extends downwards, and the partition walls of the two lateral walls are respectively provided with a plurality of third discharge holes and a plurality of fourth discharge holes, and first flow diverters, which project toward an inside of the grill body, are respectively provided below the third and fourth discharge holes, wherein the third and fourth discharge holes in the partition walls are respectively spaced upwards apart from the first and second discharge holes in the radiation plate and the partition walls are positioned between the two lateral walls of the grill body and the two lateral plates of the radiation plate such that the air discharged from the first and second suction fans is divided into an air stream, which is discharged from the first and second discharge holes by means of the first flow diverter, and an air stream, which is discharged from the third and fourth discharge holes by means of the second flow diverter, and the air stream discharged from the third and fourth discharge holes is positioned above the air stream discharged from the first and second discharge holes, thus creating a double air curtain from the two air streams in the same direction.

Each of the first and second flow diverters may be formed by a horizontal wall or a sloping wall which is inclined downwards toward the inside of the grill body.

The ratio of an amount of the air stream discharged from the first and second discharge holes and an amount of the air stream discharged from the third and fourth discharge holes may be controlled by the ratio of a distance between each of the partition walls and a corresponding one of the lateral plates of the radiation plate and a distance between each of the partition walls and a corresponding one of the lateral walls of the grill body.

The ratio of an amount of the air stream discharged from the first and second discharge holes and an amount of the air stream discharged from the third and fourth discharge holes may be controlled by the ratio of a size of each of the first and second discharge holes and a size of each of the third and fourth discharge holes.

Each of the lateral walls of the grill body may include a lower lateral wall which is inclined toward an outside of the grill body and an upper lateral wall which is inclined toward an inside of the grill body.

### Advantageous Effects

The electric grill equipped with a double air curtain-type dual air purification and circulation system according to the present invention creates dual air streams above the grill plate. Consequently, it is possible to completely prevent a phenomenon in which air containing oil vapor, smoke, heat and odor generated above the grill plate diffuses to the outside and to reliably create the first air circulation flow and the second air circulation flow by the first suction fan and the second suction fan.

### DESCRIPTION OF DRAWINGS

FIG. 1 is a cross-sectional view illustrating an air circulation flow in a conventional electric grill;

FIG. 2 is a cross-sectional view illustrating an air circulation flow in an electric grill equipped with a double air curtain-type dual air purification and circulation system according to the present invention; and

FIG. 3 is an enlarged cross-sectional view of portion “C” of FIG. 2.

Description of Major Reference Numerals of Drawings

| | |
|---|---|
| 100: grill body | 101, 102: lateral wall |
| 110: oil tray | 121: first suction fan |
| 122: second suction fan | 150: radiation plate |
| 151, 152: lateral plate | 153: first discharge hole |
| 154: second discharge hole | 155: bottom plate |
| 157: through hole | 158: flange |
| 161: heater | 170: grill plate |
| 171: oil discharge nozzle | 181: lower lateral wall |
| 182: upper lateral wall | 183: partition wall |
| 184: third discharge hole | 185: fourth discharge hole |
| 186: first flow diverter | 187: second flow diverter |

### BEST MODE

Hereinafter, an electric grill equipped with a double air curtain-type dual air purification and circulation system will be described with reference to the accompanying drawings. In the following description, if it is decided that a detailed description of known functions or configurations related to the invention would make the subject matter of the invention unclear, such detailed description is omitted.

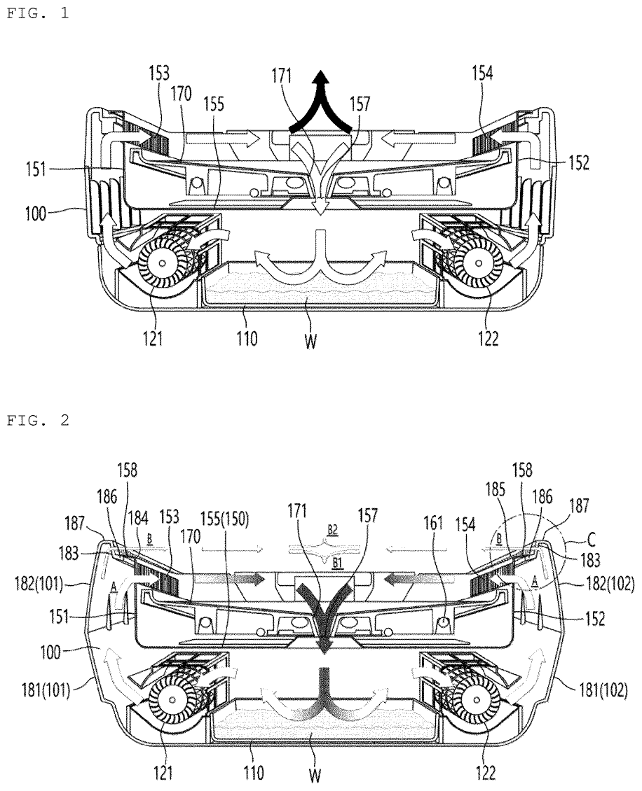

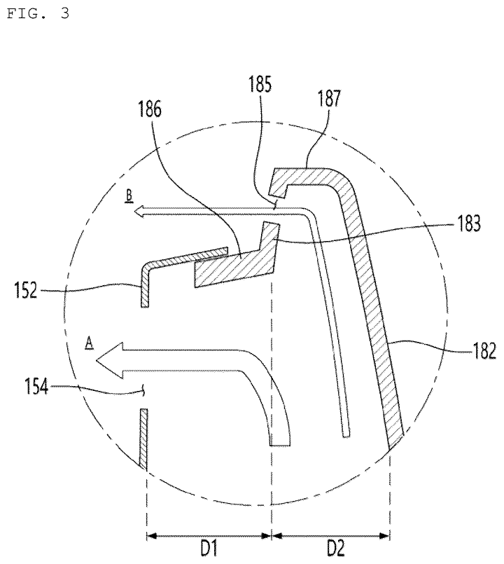

FIG. 2 is a cross-sectional view illustrating air circulation flow in an electric grill equipped with a double air curtain-type dual air purification and circulation system according to the present invention.

Referring to FIG. 2, the electric grill equipped with a double air curtain-type dual air purification and circulation system according to the present invention includes a grill body 100, an oil tray 110 disposed in the lower portion of the grill body 100 to store water therein, suction fans 121 and 122 disposed at both sides of the oil tray 110, a radiation plate 150 coupled to the grill body 100 in the state of being spaced upwards apart from the oil tray 110 and the suction fans 121 and 122, a grill plate 170 installed at a position spaced upwards apart from the radiation plate 150, and a heater 161 disposed below the grill plate 170.

The grill plate 170 is provided with an oil discharge nozzle 171 which is formed in the center of the grill plate 170 in the longitudinal direction of the grill plate 170.

In the present invention, the oil discharge nozzle 171 serves not only to collect oil generated during cooking to the center of the grill plate 170 and discharge the oil to the oil tray 110 but also to discharge air containing oil vapor, smoke, heat and odor generated over the grill plate 170 toward the oil tray 110 positioned below the oil discharge nozzle 171, as described later.

A through hole 157 is longitudinally formed in the center of the bottom plate 155 of the radiation plate 150, and the oil discharge nozzle 171 of the grill plate 170 is inserted into the through hole 157 and is coupled thereto. Accordingly, the radiation plate 150 divides the interior space of the grill body 100 into an upper space in which the heater 161 is positioned and a lower space in which the suction fans 121 and 122, thereby preventing the suction fans 121 and 122 from being heated and damaged due to heat generated by the heater 161.

Furthermore, a plurality of first discharge holes 153 and a plurality of second discharge holes 154 are formed in upper portions of both lateral plates 151 and 152 in a longitudinal direction such that the air blown by the suction fans 121 and 122 is supplied onto the grill plate 170 to form an air curtain (see arrow “A” in FIG. 2).

Although the kind of the suction fans 121 and 122 is not particularly limited, each of the suction fans preferably has an elongated shape in order to form uniform air curtains over the grill plate 170.

In the present invention, the suction fans 121 and 122 includes a first suction fan 121 and a second suction fan 122 which are positioned at both sides of the lower space of the grill body 100 with the oil tray 110 positioned below the oil discharge nozzle 171 being interposed therebetween.

Consequently, the first suction fan 121 sucks the air containing oil vapor, smoke, heat and odor, generated in the space on the grill plate 170, through the oil discharge nozzle 171 and supplies the air to the space on the grill plate 170 through the first discharge holes 153 in the radiation plate 150, thus creating an air circulation flow. Meanwhile, the second suction fan 122 sucks the air containing oil vapor, smoke, heat and odor, generated in the space on the grill plate 170, through the oil discharge nozzle 171 and supplies the air to the space on the grill plate 170 through the second discharge holes 154, thus creating air circulation flow.

Here, by virtue of the suction force of the first suction fan 121 and the second suction fan 122, the air containing oil vapor, smoke, heat and odor, discharged through the oil discharge nozzle 171, is directed to the oil tray 110 positioned below the oil discharge nozzle 171, is purified by contact with the water W stored in the oil tray 110, and is introduced into the first suction fan 121 and the second suction fan 122. For reference, the color of the arrow shown in FIG. 2 indicates a purification degree of the air (as color becomes dark, the contamination of the air increases).

In the present invention, each of both lateral walls 101 and 12 of the grill body 100 has a curved shape overall such that the central portion thereof is convex outwards. To this end, the lower lateral wall 181 of each of both the lateral walls 101 and 102 is sloped toward the outside of the grill body 110 and the upper latera wall 182 of each of the both lateral walls 101 and 102 is sloped toward the inside of the grill body 100. By virtue of the curved shape of each of both the lateral walls 101 and 102, local eddying flow and flow resistance and noise are reduced, and the first and second air circulation flows are more efficiently created.

Each of both the lateral walls 101 and 102 of the grill body 100 is provided with a partition wall 183 which is bent into a “U” shape at the upper end of the upper lateral wall 182 and extends downwards. The partition walls 183 of the two lateral walls 101 and 102 are provided with a plurality of third discharge holes 184 and a plurality of fourth discharge holes 185 formed therethrough, and are provided with first flow diverters 186 which are positioned below the third discharge holes 184 and the fourth discharge holes 185 and extend toward the grill plate 170. The upper end of each of the upper lateral walls 182 and the upper end of each of the partition walls 183 are connected to each other via a second flow diverter 187.

Each of the first flow diverter 186 and the second flow diverter 187 may be formed by a horizontal wall or a sloping wall which is inclined downwards toward the grill plate 170.

Flanges 158, which are bent outwards at the upper ends of the two lateral plates 151 and 152 of the radiation plate 150, are positioned on the upper surfaces of the first flow diverters 186. Consequently, the third discharge holes 184 and the fourth discharge holes 185 in the partition walls 183 are positioned higher than the first discharge holes 153 and the second discharge holes 154 in the radiation plate 150.

Each of the partition walls 183 is positioned between a corresponding one of the upper lateral walls and a corresponding one of the two lateral plates 151 and 152 of the radiation plate 150. Accordingly, the air discharged from the first suction fan 121 and the second suction fan 122 are divided into an air stream A, which is discharged through the first discharge holes 153 and the second discharge holes 154 by means of the first flow diverters 186, and an air stream B, which is discharged through the third discharge holes 184 and the fourth discharge holes 185 by means of the second flow diverters 187. The air stream B discharged through the third discharge holes 184 and the fourth discharge holes 185 are positioned over the air stream A discharged through the first discharge holes 153 and the second discharge holes 154, thus forming a double air curtain (see arrow “B” in FIG. 2).

Therefore, the air streams formed by air, which are supplied to the space on the grill plate 170 through the first discharge holes 153 and the second discharge holes 154, collide with each other above the oil discharge nozzle 171 of the grill plate 170, and then diffuse to the outside of the grill body 100, is blocked by an air stream B1 discharged through the third discharge holes 184 and the fourth discharge holes 185, and is sucked into the oil discharge nozzle 171 of the grill plate 170 together with the air stream B1 discharged through the third discharge holes 184 and the fourth discharge holes 185.

Meanwhile, although an air stream B2 is also formed by air, which is supplied to the space on the grill plate 170 through the third discharge holes 184 and the fourth discharge holes 185, collide with each other above the oil discharge nozzle 171 of the grill plate 170 and then diffuse to the outside of the grill body 100, the air stream B2 contains only purified air, thus preventing a problem in that odor and smoke generated during roasting of meat diffuse into a room interior and contaminate the air in the room interior.

Furthermore, because a portion of the air discharged from the first suction fan 121 and the second suction fan 122 is supplied to the space on the grill plate 170 through the third discharge holes 184 and the fourth discharge holes 185, the amount of air discharged through the first discharge holes 153 and the second discharge holes 154 is smaller than the amount of air discharged from the first suction fan 121 and the second suction fan 122. Consequently, the possibility that the air, which is supplied to the space on the grill plate 170 through the first discharge holes 153 and the second discharge holes 154, collide with each other above the oil discharge nozzle 171 of the grill plate 170 thus creating air turbulence is lowered. As a result, suction force with which air is sucked into the oil discharge nozzle 171 of the grill plate 170 increases, and the first air circulation flow and the second air circulation flow are reliably created.

The ratio of the amount of air stream A discharged through the first discharge holes 153 and the second discharge holes 154 and the amount of air stream B discharged through the third discharge holes 184 and the fourth discharge holes 185 may be controlled by the ratio of the size of the first and second discharge holes 153 and 154 and the size of the third and fourth discharge holes 184 and 185 as well as the ratio of the distance D1 between the partition walls 183 and the lateral plates 151 and 152 and the distance D2 between the partition walls 183 and the upper lateral walls 182 (see FIG. 3).

The ratio of the amount of air stream A discharged through the first discharge holes and the second discharge holes 154 and the amount of air stream B discharged through the third discharge holes 184 and the fourth discharge holes 185 is preferably within the range of 9:1 to 7:3. If the ratio exceeds 9:1, the effect of the double air curtain according to the present invention is not obtained. If the ratio is below 7:3, the first air circulation flow and the second air circulation flow are weakened, thus decreasing the effect of purification.

As described above, the electric grill equipped with a double air curtain-type dual air purification and circulation system according to the present invention creates dual air streams above the grill plate 170. Consequently, it is possible to completely prevent a phenomenon in which air containing oil vapor, smoke, heat and odor generated above the grill plate 170 diffuses to the outside and to reliably create the first air circulation flow and the second air circulation flow by the first suction fan 121 and the second suction fan 122.

The embodiments disclosed in the specification and the accompanying drawings are provided only to easily explain the technical idea of the present invention, and are not used to limit the scope of the present invention defined by the appended claims. Accordingly, those skilled in the art will understand that various modifications and other equivalent embodiments are possible from the above disclosure.

1. An electric grill equipped with a double air curtain-type dual air purification and circulation system, comprising:
a grill body;
an oil tray disposed in a lower portion of the grill body to store water therein;
suction fans disposed at both lateral sides of the oil tray;
a radiation plate coupled to the grill body at a position spaced upwards apart from the oil tray and the suction fans, a through hole being longitudinally formed in a center of a bottom plate of the radiation plate and a plurality of first discharge holes and a plurality of second discharge holes being respectively formed in both lateral plates of the radiation plate spaced apart from both lateral walls of the grill body; and
a grill plate spaced upwards apart from the bottom plate of the radiation plate so as to be positioned above the first discharge holes and the second discharge holes in the radiation plate, an oil discharge nozzle being longitudinally formed in a center of the grill plate,
wherein:
the suction fans comprises first and second suction fans positioned at both sides of a lower space of the grill body with the oil tray disposed below the oil discharge nozzle being interposed therebetween,
the first suction fan sucks air containing oil vapor, smoke, heat and odor, generated in a space on the grill plate, through the oil discharge nozzle and supplies the air to the space on the grill plate through the first discharge holes in the radiation plate, thus creating a first air circulation flow,
the second suction fan sucks air containing oil vapor, smoke, heat and odor, generated in the space on the grill plate, through the oil discharge nozzle and supplies the air to the space on the grill plate through the second discharge holes in the radiation plate, thus creating a second air circulation flow,
by virtue of suction force of the first and second suction fans, the air containing the oil vapor, the smoke, the heat and the odor, discharged from the oil discharge nozzle, is brought into contact with water stored in the oil tray positioned below the oil discharge nozzle so as to be purified and is introduced into the first and second suction fans,
the two lateral walls of the grill body are respectively provided with partition walls each of which is bent into a “U” shape at an upper end of an upper end of each of the two lateral walls and extends downwards,
the partition walls of the two lateral walls are respectively provided with a plurality of third discharge holes and a plurality of fourth discharge holes, and first flow diverters, which project toward an inside of the grill body, are respectively provided below the third and fourth discharge holes,
the third and fourth discharge holes in the partition walls are respectively spaced upwards apart from the first and second discharge holes in the radiation plate and the partition walls are positioned between the two lateral walls of the grill body and the two lateral plates of the radiation plate such that the air discharged from the first and second suction fans is divided into an air stream, which is discharged from the first and second discharge holes by means of the first flow diverter, and an air stream, which is discharged from the third and fourth discharge holes by means of the second flow diverter, and the air stream discharged from the third and fourth discharge holes is positioned above the air stream discharged from the first and second discharge holes, thus creating a double air curtain from the two air streams in the same direction.

2. The electric grill equipped with a double air curtain-type dual air purification and circulation system according to claim 1, wherein each of the first and second flow diverters is formed by a horizontal wall or a sloping wall which is inclined downwards toward the inside of the grill body.

3. The electric grill equipped with a double air curtain-type dual air purification and circulation system according to claim 1, wherein a ratio of an amount of the air stream discharged from the first and second discharge holes and an amount of the air stream discharged from the third and fourth discharge holes is controlled by a ratio of a distance between each of the partition walls and a corresponding one of the lateral plates of the radiation plate and a distance between each of the partition walls and a corresponding one of the lateral walls of the grill body.

4. The electric grill equipped with a double air curtain-type dual air purification and circulation system according to claim 1, wherein a ratio of an amount of the air stream discharged from the first and second discharge holes and an amount of the air stream discharged from the third and fourth discharge holes is controlled by a ratio of a size of each of the first and second discharge holes and a size of each of the third and fourth discharge holes.

5. The electric grill equipped with a double air curtain-type dual air purification and circulation system according to claim 1, wherein each of the lateral walls of the grill body comprises a lower lateral wall which is inclined toward an outside of the grill body and an upper lateral wall which is inclined toward an inside of the grill body.
